(19) United States
(12) Patent Application Publication
(10) Pub. No.: US 2009/0075732 A1
(43) Pub. Date: Mar. 19, 2009

(54) SCENARIO GAME

(76) Inventor: Londa Nichele Sanders, Glen Burnie, MD (US)

Correspondence Address: JOHN S. KENDALL, 225 WEST WASHINGTON STREET, SUITE 2200, CHICAGO, IL, 60606, US

(21) Appl. No.: 11/856,756

(22) Filed: Sep. 18, 2007

(51) Int. Cl. A63F 3/00; A63F 1/00; A63F 9/04; A63F 13/00

(52) U.S. Cl. 463/31; 273/138.1; 273/146; 273/236; 273/292

(57) ABSTRACT

The present invention, a SCENARIO GAME comprising a deck of scenario cards, a deck of pass cards, a deck of agree cards, a deck of disagree cards and a random event generator (dice); seeks to provide the participants a means whereby the participants are encouraged to engage each other in conversation through the medium of a stimulating and non-threatening game wherein players provide responses to various scenarios, which are scored by the other players by selecting one of either a disagree, an agree or pass card, and the role player is awarded points based upon the output of a random event generator that matches the other players categorization of the role player's response. The turn shifts to the next player and the process continues until an arbitrary score is reached, there is a shortage of cards or the players decide to quit. In another embodiment, the scenario game further comprises a container having a visual score tracker and a fitted card holder and unique game pieces to represent each player. An animated computer software implemented variant is also disclosed and claimed. Additional embodiments providing differing arrangements of the primary elements are also disclosed and claimed.

### BACKGROUND OF THE INVENTION

1. Field of the Invention

The present invention specifically relates to a SCENARIO GAME utilized to stimulate conversation and amusement among the participants whereby two (2) or more individuals randomly assume a particular role and are subsequently placed in the position of interfacing with the other player(s) while addressing various randomly selected situations. Each role player is then scored on their ability to develop an acceptable solution within a given time constraint by the other participant(s) who select Agree or Disagree, or Pass cards having various point totals. The role player then must elicit a response from a random event generator in this case a special dice having the designations for Pass (P), Agree (A) and Disagree (D), which is rolled. The role player is awarded points based upon matching the random event generator response with the cards selected by the participants. Play continues with the next player in one of either a clockwise, counter-clockwise or random fashion until an arbitrary score is reached or there are no longer any Pass, Agree or Disagree cards remaining. In another embodiment the game may be played merely to stimulate conversation and amusement by taking turns without scoring the players' responses.

2. Description of the Related Art

An effective means for encouraging social intercourse at parties and other gatherings has been the use of various games. These games have often taken the form of board games that may reflect popular elements of the current culture, or the present interest in attaining wealth or power, or demonstrating superior mental prowess in respect to a given set of facts. Though these games do serve to stimulate conversation and allow the participants to gain a rather limited insight of each others personality attributes as a means of determining if there exists a possibility for more meaningful discourse to occur, these games tend to be based upon establishing superiority based on a concise set of facts. Often the limited universe of facts, trivia and theories presented may on the outset exclude individuals having diverse interests and those lacking access to a median. An example of this would be a trivia game based on a popular television show that would challenge participants to establish their knowledge in terms of the televisions shows cast members, details of particular episodes, the history of the show, etc. Such a show would not be inviting to those who had never saw or had but scant knowledge of the show; as such these individuals are less likely to participate and in so doing reduce the quotient of possible social interactions. It would be desirable to have a game whereby individuals having a diverse universe of knowledge would be encouraged to fully participate without concern as to their ability to provide structured responses within a specific set of predetermined variables.

Another approach that has been taken to address the issues regarding the limitations posed by the aforementioned games having a limited set of correct responses has been to substitute the knowledge requirement with a random variable generator, which is typically dice, a spinner or electronic device. This device produces a random output that directs the individual player's movements in the game. In some versions upon following these instructions the player is directed to a location and must take a subsequent action based upon his directed position, which may be denoted by a game piece of sorts. Though such games fully address the issue of exclusion presented by the knowledge specific games, another issue arises that must be considered is the monotony that occurs based on the repetitive cycle that flows from these games. This typically results in the disengagement of players long before the game has run its course and thereby limits the possibility for stimulating further communication among the players. This problematic feature of chance driven games is further encouraged by the fact that such games tend to appeal to the competitive aspect of the player's psyche, wherein the player is considerably less likely to be engaging and conversant. In fact, the player's ability to socially engage his fellow participants is inversely proportional to the player's keenness to competition. It is obvious that this attempt falls far short of the goal of providing a game that encourages individuals to participate, wherein stimulating social interaction is accomplished.

Given the multitude of shortcomings and disadvantages regarding the existing approaches to a game for encouraging social intercourse it would be desirable to have an affordable and convenient solution within the grasp of the average consumer of this commodity that could allow the participants to play without regard to the diversity of the players universe of knowledge and would situate all players equally by minimizing subjective elements and aspects of chance. The present invention satisfies such a need.

### SUMMARY OF THE INVENTION

The present invention specifically relates to a SCENARIO GAME utilized to stimulate conversation and amusement among two or more participants whereby one of the individuals is selected to assume a particular randomly assigned role, thus becoming a role player and is subsequently placed in the position of interfacing with the other player(s) while addressing various randomly selected situations based upon a selected scenario card. Each role player is then scored on their ability to develop an acceptable solution within a given time constraint by the other participant(s) who select Agree or Disagree, or Pass cards having various point totals. The role player then must elicit a response from a random event generator in this case a special dice having the designations for Pass (P), Agree (A) and Disagree (D), which is rolled. The role player is awarded points based upon matching the random event generator response with the cards selected by the participants. The players may then place the unselected cards in a discard pile or return the cards to their respective deck. Play continues with the next player in one of either a clockwise, counter-clockwise or random fashion until a predetermined score is reached or there are no longer any Pass, Agree or Disagree cards remaining. In another embodiment the game may be played merely to stimulate conversation and amusement by taking turns without scoring the players' responses.

The present invention does not rely on any specific knowledge or expertise to which players must subscribe to play the game and garner the benefits of personal interaction that simultaneously occur. As an individual participant in the position as a role player may bring a litany of personal experiences to draw upon or ignore when addressing the particular scenario they are faced with, so are the other game participants similarly situated that must rate the role player's response by choosing to pass, agree or disagree. The possibility of the subjective nature presenting a negative impression in respect to the participant role player are neutralized by utilizing a random event generator, which in one embodiment may be a specialized dice, to select one category of response (one of either agree, disagree and pass). Once the role player initiates the random event generator (dice) and receives an output, the role player collects the matching response cards from the other participants and is awarded those points. The initiation of this selection process by the random event generator tends to nullify the possibility of negative consequences of participation as a function of the other participants subjective judgments of the role player's response, thus rendering the scenario game as a modified game of chance and not as an indicator of personality or a psychological evaluation tool. The turn then shifts to the next participant that must assume the role of the role player and select a scenario card and subsequently repeat the process.

In another embodiment the container for the scenario game, which may be a rectangular box comprising a bottom section that is received in a top section, which may respectively serve a holder for the game cards (bottom section) whereby designated locations for the each category of game card is indicated on the interior base of the bottom section of the container; and a visual score tracker (top section) whereby an illustrative score tracker may be printed on the interior base of the top section of the container, which may further employ game pieces representing the individual participants that are placed in a location corresponding to the individual participant's score. In a variant of this embodiment the scenario game container bottom section may have a fitted card holder that approximates the container bottom section interior dimensions, which may provide for the exact placement of the game cards and game pieces while simultaneously providing ready access to both for the convenience of the participants.

In another embodiment, the scenario game may be implemented utilizing a computer based program that is capable of providing an image to a computer monitor and accepting an input from an external input device i.e., a keyboard, mouse, joystick or any similarly suited device to acknowledge the individual players choices. This embodiment would require that the following steps be taken to emulate the methodology of the scenario game;
1. The participants select the number of players.
2. The computer program assigns a unique game piece to each player.
3. The individual players' position is shown on a visual score tracker with their respective game pieces.
4. The computer program randomly selects a first role player.
5. The computer program introduces a randomly selected scenario for the role player.
6. The computer program allows the role player a prescribed period of time to address his response to the other players, upon doing so providing an input signaling completion of this task to the computer program.
7. The computer program allows the other players a prescribed period of time to openly critique the role player's response and determine whether they agree, disagree or pass in respect to the role player's response and input their choices.
8. Upon receipt of all the inputs the computer program will initiate the visual random event generator, which will display a choice between those options of agree, disagree or pass and will subsequently assign points based on the agreement of the random event generator and the other participants inputs.
9. The computer program will then display the role player's acquired points, which shall be shown along with the role player's new position on the visual score tracker.
10. The computer program repeats this sequence for each player in turn until a predetermined point total is met by one of the players, who is declared the winner.

In this embodiment an animated visual simulation of the random device generator is provided to the monitor and the scoring of each individual player is accomplished by a summation program embedded in the computer software routine that would provide an output to an animated visual simulation of the visual score tracker that would indicate the individual player's new position relative to this operation. Additional predetermined animation elements may be incorporated at the players' discretion to enhance the participation and engagement of the players. This process would be collectively repeated for each individual player until a winner is determined.

### BRIEF DESCRIPTION OF THE DRAWINGS

FIG. 1 is a perspective drawing of the SCENARIO GAME, showing several players engaged in the act of playing the game, wherein the role player is drawing a card from the bottom section of the game container, while the players game pieces are shown on the visual score tracker incorporated in the interior of the top section of the game container.

FIG. 1A is an exploded perspective drawing of the SCENARIO GAME, showing the top and bottom sections of the game container, wherein the players game pieces are shown on the visual score tracker incorporated into the interior of the top section of the game container and the game pieces and cards are stored in a fitted card holder incorporated into the container bottom section.

FIG. 2 is a top view of a scenario card.

FIG. 3 is a bottom view of a scenario card.

FIG. 4 is a top view of a pass card.

FIG. 5 is a bottom view of a pass card.

FIG. 6 is a top view of an agree card.

FIG. 7 is a bottom view of an agree card.

FIG. 8 is a top view of a disagree card.

FIG. 9 is a bottom view of a disagree card.

FIG. 10 is a top view of the container top section having a visual score tracker incorporated therein.

FIG. 11 is a top perspective view of the random event generator (dice).

FIG. 12 is a bottom perspective view of the random event generator (dice).

FIG. 13 is a perspective view of a representative game piece.

FIG. 14 is a flow diagram describing the preferred method of playing the scenario game utilizing a computer/software implemented means.

FIG. 15 is a top view of the container top section having an alternative embodiment of the visual score tracker.

FIG. 16 is a flow diagram describing an alternative method of playing the scenario game utilizing a computer/software implemented means.

### DETAILED DESCRIPTION OF THE PRESENTLY PREFERRED EMBODIMENTS

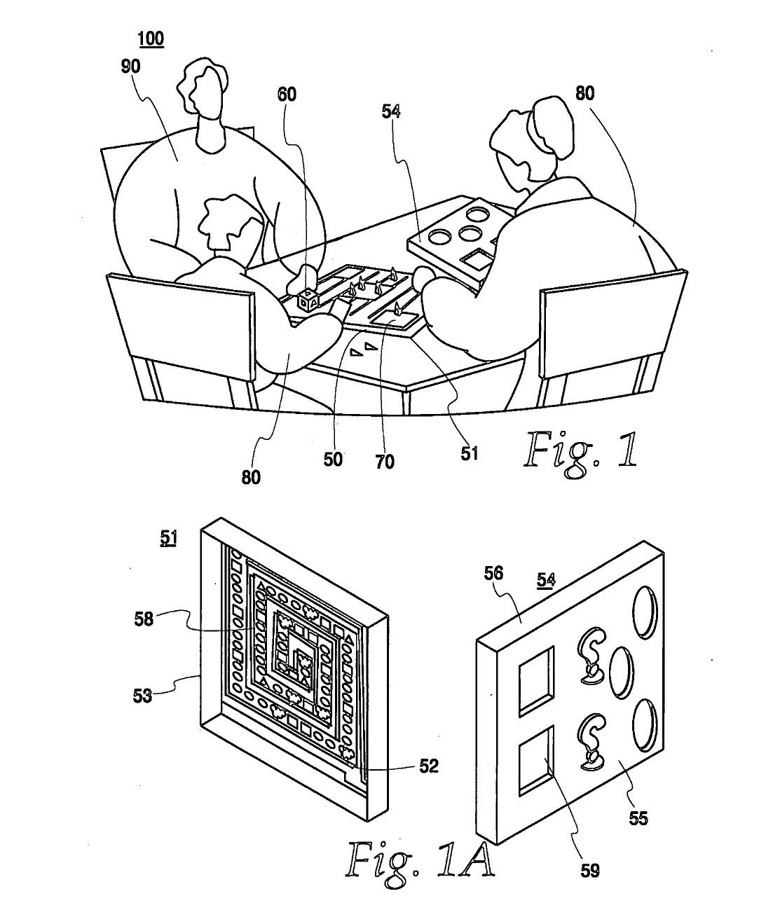

Referring to FIGS. 1 through 14 illustrate the preferred embodiments of a SCENARIO GAME in accordance with the present invention.

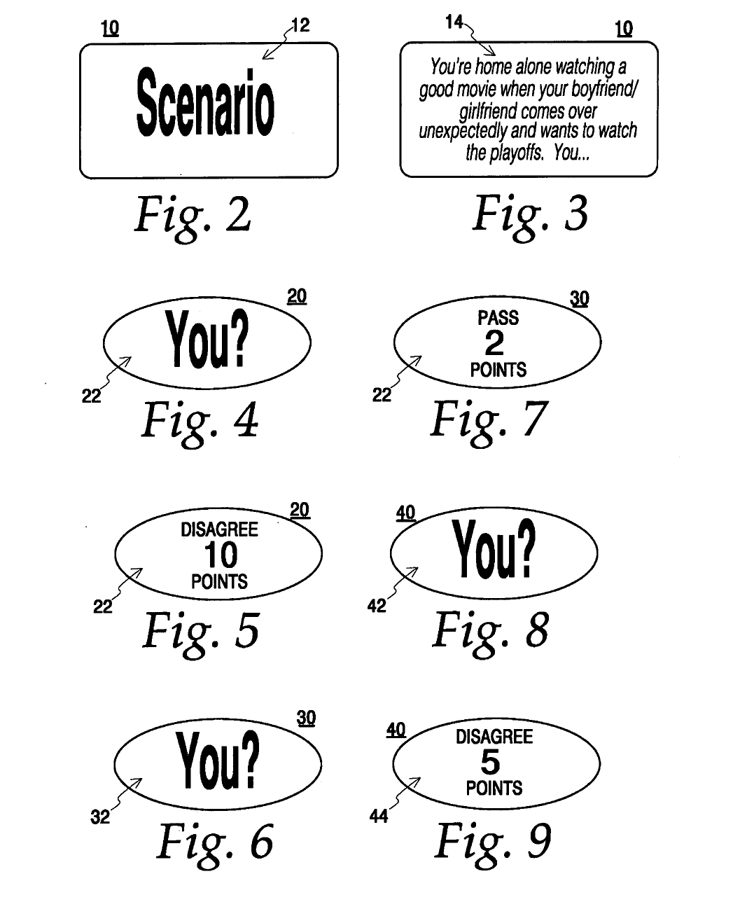

Referring to FIG. 1 the present embodiment of the Scenario Game is generally shown at 100. The Scenario Game 100 may comprise a deck of scenario cards 10 (FIGS. 2, 3), a deck of disagree cards 20 (FIGS. 4, 5), a deck of pass cards 30 (FIGS. 6, 7), a deck of agree cards 40 (FIGS. 8, 9), a random event generator 60 (FIGS. 11, 12). The scenario 10 (FIGS. 2, 3), pass 30 (FIGS. 6, 7), agree 40 (FIGS. 8, 9) and disagree card 20 (FIGS. 4, 5) decks are chosen from a predetermined geometric shape from a group consisting of rectangles, stars, ellipses, diamonds, triangles and regular polygons; constructed of press board, plastic, paper or any other material known in the Gaming Arts to be suitable for the purpose of playing card construction, and may incorporate various themes and colors to maintain the interest of a player 80. The scenario cards 10 (FIGS. 2, 3) may comprise a first side 12 (FIG. 2), which may bear the term “SCENARIO” printed thereon, and a second side 14 (FIG. 3) wherein scenarios that are selected from a group of life experiences consisting of financial dilemmas, spiritual matters, romantic/sexual experiences, work/career experiences, educational experiences, family matters, pop culture and health related issues, are printed thereon. A brief example of the possible scenarios is provided in TABLE 1. The disagree cards 20 may comprise a first side 22 (FIG. 4), which is printed with the word “YOU?”, and a second side 24 (FIG. 5), which is printed with the words “DISAGREE 10 POINTS”. The pass cards 30 may comprise a first side 32 (FIG. 6), which is printed with the word “YOU?”, and a second side 34 (FIG. 7), which is printed with the words “PASS 2 POINTS”. The agree cards 40 may comprise a first side 42 (FIG. 8), which is printed with the word “YOU?”, and a second side 44 (FIG. 9), which is printed with the words “AGREE 5 POINTS”. The decks of scenario cards 10 (FIGS. 2, 3), disagree cards 20 (FIGS. 4, 5), pass cards 30 (FIGS. 6, 7), agree cards 40 (FIGS. 8, 9) may range in quantity from one hundred to two hundred, five hundred to seven hundred, two to three hundred and five hundred to seven hundred, respectively. The decks of scenario cards 10 (FIGS. 2, 3), disagree cards 20 (FIGS. 4, 5), pass cards 30 (FIGS. 6, 7), agree cards 40 (FIGS. 8, 9) may each possess a unique color or design to allow the players 80 (FIG. 1) to distinguish each card type and maintain the segregation of the cards.

The Scenario Game 100 may be utilized to stimulate conversation and amusement among a group of two or more participant players 80 whereby an individual player 80 randomly assumes a particular role, thus becoming a role player 90 by randomly selecting a scenario card 10 (FIGS. 2, 3) from the deck and is subsequently placed in the position of interfacing with the other player(s) 80 while addressing various randomly selected situations. Each role player 90 is then scored on their ability to develop an acceptable solution within a given time constraint by the other participant(s) 80 who select one of either an Agree card 40 (FIG. 8, 9), Disagree card 20 (FIG. 4, 5) or Pass card 30 (FIG. 6, 7) having various point totals. The role player then must elicit a response from a random event generator 60 (FIG. 11, 12) in this case a special dice having a first side 61 (FIG. 11), a second side 62 (FIG. 11), a third side 63 (FIG. 11), a fourth side 64 (FIG. 12), a fifth side 66 (FIG. 12) and a sixth side 66 (FIG. 12). The random event generator 60 (FIG. 11, 12) has the designations for Pass (P), Agree (A) and Disagree (D), respectively assigned to the first side 61 (FIG. 11)/fourth side 64 (FIG. 12), second side 62 (FIG. 11)/fifth side 65 (FIG. 12) and third side 63 (FIG. 11)/sixth side 66 (FIG. 12). The random event generator 60 (FIGS. 11, 12) may be constructed of any material known in the Gaming Arts suitable for the construction of dice in accordance with the accepted specifications for dice in respect to peculiarities regarding shape, size and weight. The random event generator 60 (FIGS. 11, 12) is rolled and the role player 90 is awarded the points from the other players 80 that match their selection of cards with the designation on the side facing up on the random event generator 60 (FIGS. 11, 12). The role player 90 is awarded points based upon matching the random event generator 60 response with the cards selected by the participants. In the event the role player 90 fails to elicit any points for failing to match the designation on the random event generator 60 (FIGS. 11, 12) with the card selection by the other players 80 (FIG. 1). Play continues with the next player 80 who then becomes the role player 90, in one of either a clockwise, counter-clockwise or random fashion until a predetermined score is reached or there is no longer any Pass 30 (FIGS. 6, 7), Agree 40 (FIGS. 8, 9) or Disagree 20 (FIGS. 4, 5) cards remaining. In another embodiment the scenario game 10 may be played merely to stimulate conversation and amusement by taking turns without scoring the role players' 90 responses.

In another embodiment of the Scenario Game 100, the random event generator 60 (FIGS. 11, 12) may comprise a portable electronic means capable of producing the designations of P, A and D, respectively Pass, Agree and Disagree. This electronic means may be any random number generator known in the Electronic and Mathematical Arts for producing a random output limited to a plurality of three or more variables upon the initiation of a user. The electronic means may further provide a visual output and optional audio output for visually impaired participants. In a further embodiment of the random event generator 60, may also incorporate additional features such as a calculator or programmable means for keeping score and providing audio and visual output of this data, and voice recognition means to allow for the introduction of audio commands to provide voice prompts to the elicit responses and actions from the electronic means.

Referring to FIG. 1A, another embodiment the Scenario Game 100 may also comprise a container 60 having a container top section 51, which may be constructed of an open rectangular container comprising a top section base 52 of a predetermined length and width, having top section sides 53 adjacently attached in congruent agreement to the container top section base 62 at their respective edges so as to form an open box; and a container bottom section 54, which may be constructed of an open rectangular container comprising a bottom section base 56 of a predetermined length and width, having bottom section sides 56 adjacently attached in congruent agreement to the container bottom section base 55 at their respective edges so as to form an open box of slightly smaller length and width than the container top section 51, which shall receive the container bottom section 54. The container 60 may be constructed on any material known in the Mechanical Arts capable of producing a durable structure of economical construction having a relatively high strength to weight ration; which lends itself to portability, recyclability and bearing a wipeable surface for cleaning. The container 50 provides for the storage of the scenario game 100 components and permits the convenient transport of the scenario game 100. In another embodiment the container bottom section 54 may have pre-designated locations annotated on the container bottom section base 56 for the decks of scenario cards 10 (FIGS. 2, 3), disagree cards 20 (FIGS. 4, 5), pass cards 30 (FIGS. 6, 7) and agree cards 40 (FIGS. 8, 9). In another embodiment, the container bottom section 54 may further comprise a fitted holder 59 with designated user accessible locations for the placement of decks of scenario cards 10 (FIGS. 2, 3), disagree cards 20 (FIGS. 4, 5), pass cards 30 (FIGS. 6, 7), agree cards 40 (FIGS. 8, 9), the random event generator 60 (FIGS. 11, 12) and game pieces 70 (FIG. 13).

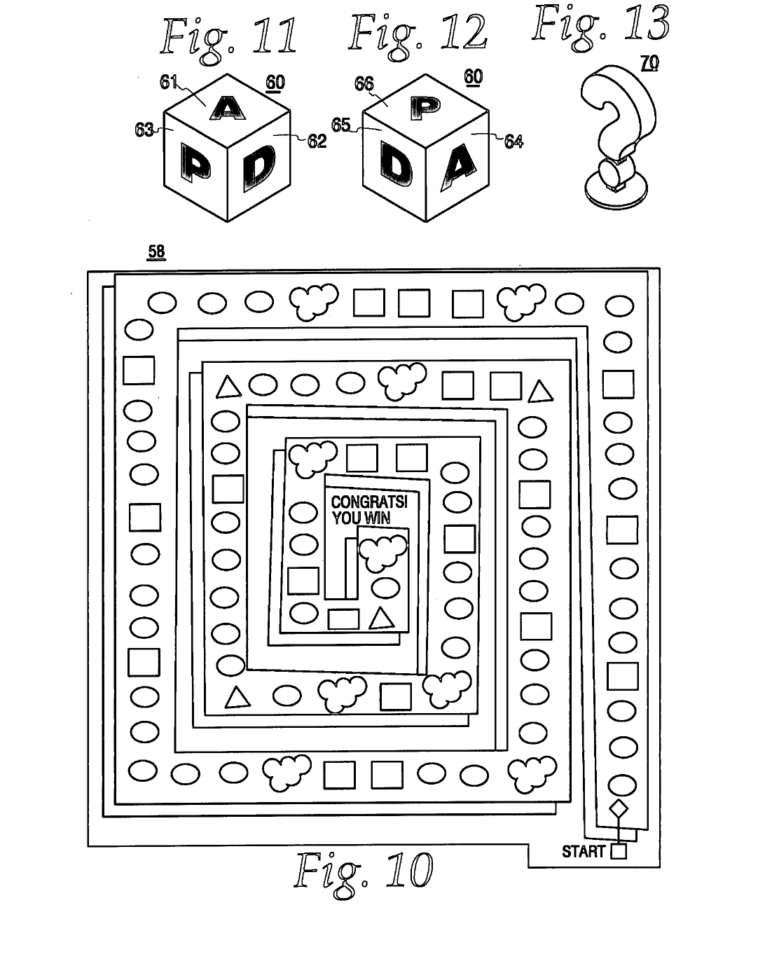

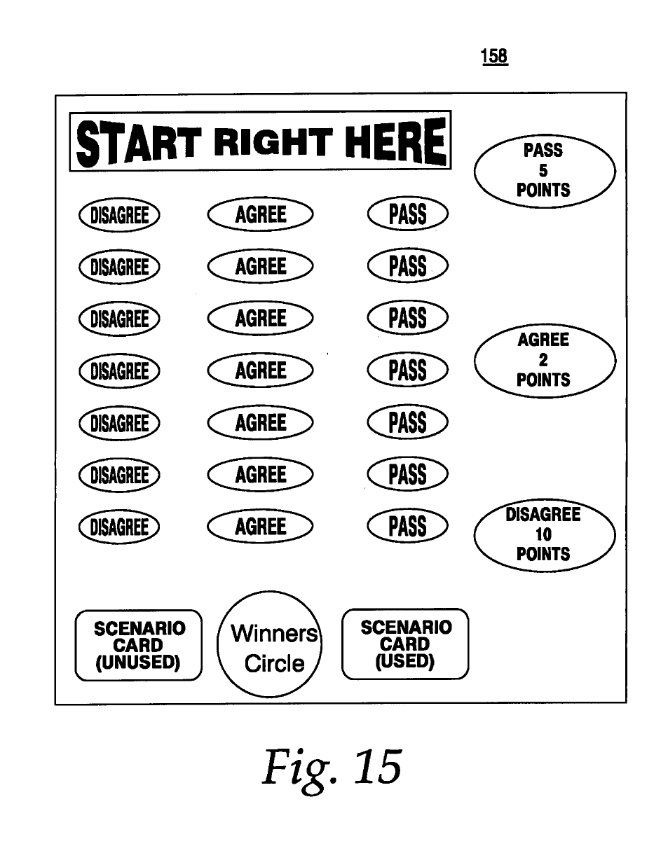

In another embodiment of the Scenario Game 100, the container top section 61 may incorporate a visual score tracker 58 (FIG. 10) or an alternate embodiment of the visual score tracker 158 (FIG. 15), which may be printed or embossed upon the container top section base 52. The visual score tracker 58 may be any circuitous design constructed so as to give prompt visual notice to the players 80 of their respective scores. This may include such designs as mazes, tortuous paths and convoluted two-dimensional geometric designs having meniscate planes, and a numerical value ranging from zero at the START and increasing at each designation on the visual score tracker 58, until a pre-determined value is met at the WINNER location. The visual score tracker 58 (FIG. 10) may incorporate various themes and pictorial depictions that reflect the scope of the scenario cards 10 (FIGS. 2, 3), about the length of the path to stimulate the interest of the players 80. The visual score tracker 58 (FIG. 10) also facilitates scoring by use of a graphic methodology rather than the use of manual arithmetic means. This is accomplished by each player 80 selecting a representative game piece 70 (FIG. 13), placing their respective game piece 70 (FIG. 13) on the START position of the visual score tracker 58 (FIG. 10) and advancing their piece in turn, in respect to the points scored until a winner is proclaimed. The game piece 70 (FIG. 13) comprises the shape of a question mark of a predetermined color to designate an individual player 80 (FIG. 1) having a base to provide self-support while it is moved about the visual score tracker 58 (FIG. 10) and may be constructed of any plastic, wood or other durable material known in the Mechanical Arts capable of suitably serving this requirement. The game pieces 70 (FIG. 13) shall each possess distinguishable predetermined colors that shall directly correlate to the number of individual players 80 (FIG. 1) and shall not be repeated. The incorporation of graphics such as stripes, patterns, circles, etc. may be used in conjunction with the color to produce readily discernible distinctions among the game pieces 70 (FIG. 13). In an alternate embodiment the game piece 70 may take the form of any geometric shape, princesses, athletes, professionals, caricatures and items related to the theme of the scenario cards 10 (FIG. 2, 3) TABLE 1. In another embodiment the visual score tracker 58 (FIG. 10) may be a separate component and comprise a board, which may be foldable to permit storage within the container 50 (FIG. 1) and being of a similar material of construction.

Referring to FIG. 15, another embodiment of the Scenario Game 100 visual score tracker is generally shown at 158, which is incorporated in the container top section 51 (FIG. 1). The alternate embodiment of the visual score tracker 158 comprises at least three columns designated by the terms DISAGREE, AGREE and PASS, each column having a like plurality of rows, wherein the columns and rows are respectively aligned in a substantial linear or curvilinear fashion designed so as to give prompt visual notice to the players 80 (FIG. 1) of their respective positions. The visual score tracker 158 may incorporate a designated starting position, labeled START RIGHT HERE wherein the individual players 80 (FIG. 1) locate their respective game pieces 70 (FIG. 13). A first role player 90 (FIG. 1) is selected, who then selects a scenario card 10 (FIG. 2) from the SCENARIO CARD (UNUSED) location, and reads the card aloud to the other players 80 (FIG. 1) thereafter placing the card in the SCENARIO CARD (USED) location. The role player 90 (FIG. 1) then formulates a response, which is stated to the other players 80 (FIG. 1), who then may discuss their opinion regarding the response and subsequently select a disagree card 20 (FIGS. 4, 5), a pass card 30 (FIGS. 6, 7) or an agree card 40 (FIGS. 8, 9) from their respective PASS, AGREE and DISAGREE locations, which mirror the player's 80 (FIG. 1) opinion of the role player's 90 (FIG. 1) response. Once all the other players 80 (FIG. 1) have selected a card indicative of their evaluation of the role player's 90 (FIG. 1) response, the role player 90 (FIG. 1) rolls the random event generator 60 (FIG. 11, 12) is awarded the points from the other players 80 that match the designation on the side facing up on the random event generator 60 (FIG. 11, 12) by collecting those cards. The role player 90 (FIG. 1) then advances his respective game piece 70 (FIG. 13) for the START RIGHT HERE position to the respective disagree, agree or pass column position in the first row that coincides with the type of points awarded points based upon matching the random event generator 60 response. In the event that the role player 90 (FIG. 1) does not earn any points the role player 90 (FIG. 1) does not advance his position on the visual score tracker 158 (FIG. 15). This process is repeated in turn for the other players 80 (FIG. 1) ask they assume the position as role player 90 (FIG. 1) until one or more players 80 (FIG. 1) have advanced their respective game piece 70 (FIG. 13) to the last row and upon receiving points for advancing reaches the WINNERS CIRCLE. If by chance two or more players 80 (FIG. 1) may reach the WINNERS CIRCLE within the span of a single turn, then each player 80 (FIG. 1) will tally their respective points, wherein the player 80 (FIG. 1) with the highest point total is declared the winner. In another embodiment the visual score tracker 158 may be a separate component and comprise a board, which may be foldable to permit storage within the container 50 (FIG. 1) and being of a similar material of construction.

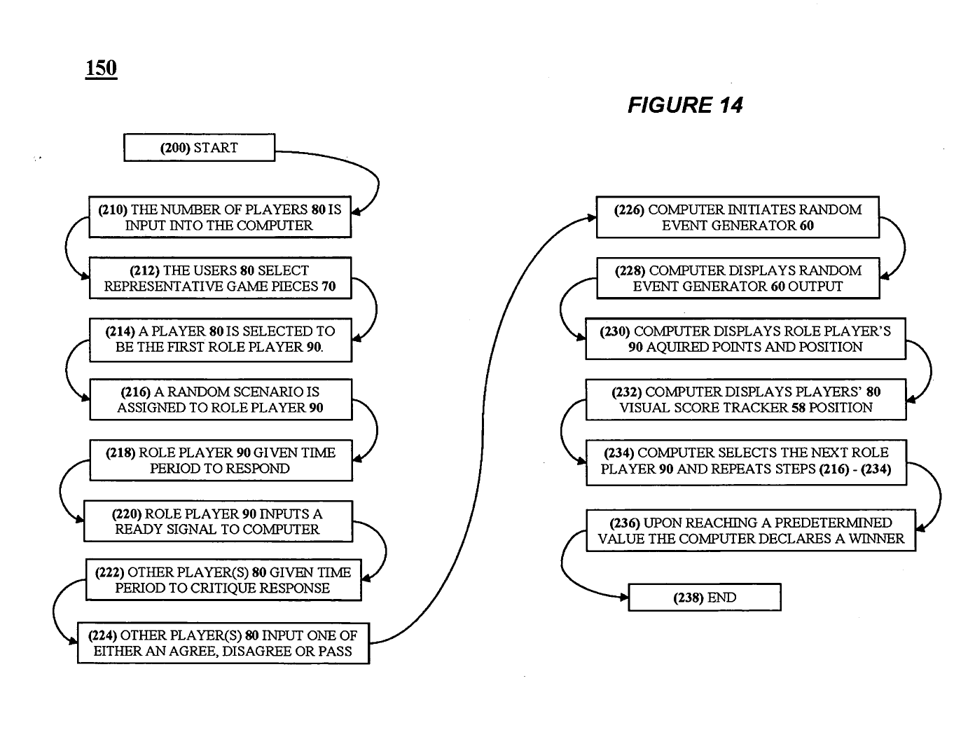

Referring to FIG. 14, a computer/software implemented flow chart for the SCENARIO GAME 100 is generally shown at 150. In this embodiment, the scenario game 100 may be implemented utilizing a computer based software program that is capable of providing various images, which may be animated, to a computer monitor upon accepting an input from one or more external operably connected input devices i.e., a keyboard, mouse, joystick or any such similarly suited device known in the Electronic Arts that acknowledge the individual players choices to the computer. This embodiment would require that the steps outlined below be taken to emulate the methodology of the scenario game;
1. The players 80 (FIG. 1) initiate power to the computer and start the game (STEP 200).
2. The number of players 80 (FIG. 1) is input into the computer (STEP 210).
3. The players 80 (FIG. 1) select representative game pieces 70 (FIG. 13) (STEP 212).
4. A player 80 (FIG. 1) is selected to be the first role player 90 (FIG. 1) (STEP 214).
5. A random scenario is assigned to the role player 90 (FIG. 1) (STEP 216).
6. The role player 90 (FIG. 1) is given a time period to respond (STEP 218).
7. The role player 90 (FIG. 1) inputs a ready signal to computer (STEP 220).
8. The other player(s) 80 (FIG. 1) is given a time period to critique the response (STEP 222).
9. The other player(s) 80 (FIG. 1) inputs one of either an agree, disagree or pass (STEP 224).
10. The computer initiates the random event generator 60 (FIGS. 11, 12) (STEP 226).
11. The computer displays the random event generator 60 (FIGS. 11, 12) output and matches the other player(s) 80 scoring input and sums the value of the matches and assigns this score to the role player 90 (FIG. 1) (STEP 228).
12. The computer displays the role player's 90 (FIG. 1) acquired points and position (STEP 230), in the event the role player 90 (FIG. 1) fails to match the other player(s) 80 (FIG. 1) inputs with the output of the random event generator 60 (FIGS. 11, 12) the role player 90 (FIG. 1) does not score any points for that turn.
13. The computer displays the players' 80 (FIG. 1) visual score tracker 58 (FIG. 10) position (STEP 232). Note that the role player 90 (FIG. 1) is only advanced if points are scored.
14. The computer selects the next role player 90 (FIG. 1) and repeats STEPS 216-234 (STEP 234).
15. Upon reaching a predetermined value the computer declares a winner (STEP 236).
16. The players 80 (FIG. 1) end the game and terminate power to the computer (STEP 238).

In this embodiment an animated visual simulation of the random device generator 60 (FIGS. 11, 12) is provided to the monitor and the scoring of each individual player 80 (FIG. 1) is accomplished by a summation program embedded in the computer software routine that provides an output to an animated visual simulation of the game piece(s) 70 (FIG. 13) in conjunction with either the visual score tracker 58 (FIG. 10) or the alternate visual score tracker 158 (FIG. 15) that would indicate the individual player's 80 (FIG. 1) new position relative to this operation. Additional predetermined animation elements may be incorporated at the players' 80 (FIG. 1) discretion to enhance the participation and engagement of the players. This process would be collectively repeated for each individual player 80 (FIG. 1) until a winner is determined. In another embodiment, the animated visual game piece(s) 70 may comprise the form of any geometric shape, princesses, athletes, professionals, caricatures and items related to the theme of the scenario cards 10 (FIG. 2, 3) TABLE 1.

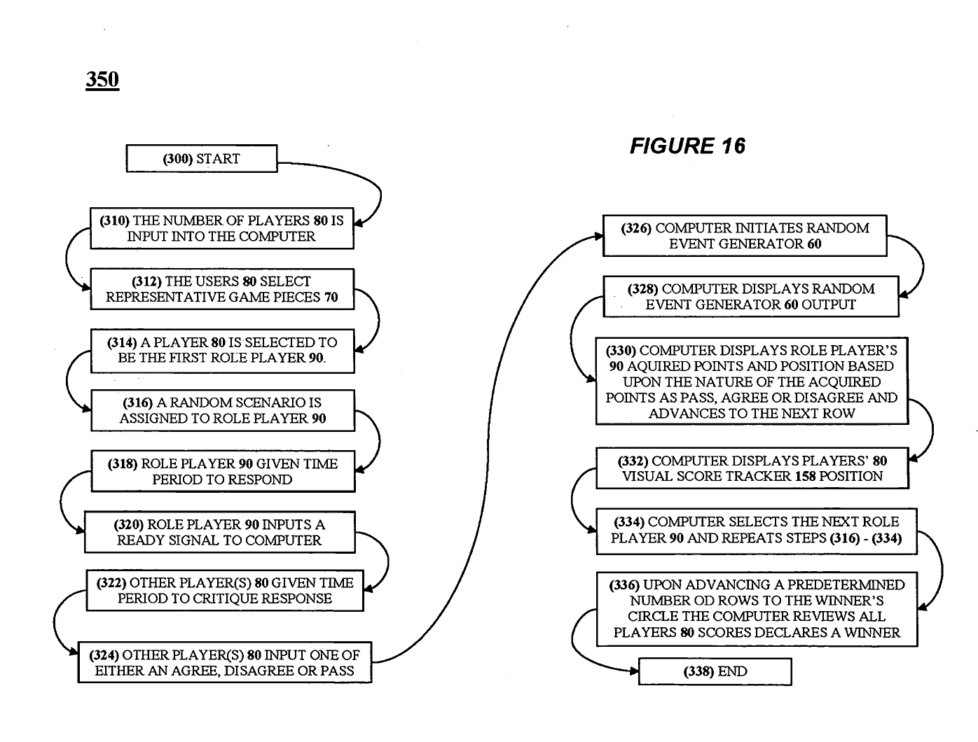

Referring to FIG. 16, a computer/software implemented flow chart for an alternate embodiment of the SCENARIO GAME 100 is generally shown at 350. In this embodiment, the scenario game 100 may be implemented utilizing a computer based software program that is capable of providing various images, which may be animated, to a computer monitor upon accepting an input from one or more external operably connected input devices i.e., a keyboard, mouse, joystick or any such similarly suited device known in the Electronic Arts that acknowledge the individual players choices to the computer. This embodiment would require that the steps outlined below be taken to emulate the methodology of the scenario game;
1. The players 80 (FIG. 1) initiate power to the computer and start the game (STEP 300).
2. The number of players 80 (FIG. 1) is input into the computer (STEP 310).
3. The players 80 (FIG. 1) select representative game pieces 70 (FIG. 13) (STEP 312).
4. A player 80 (FIG. 1) is selected to be the first role player 90 (FIG. 1) (STEP 314).
5. A random scenario is assigned to the role player 90 (FIG. 1) (STEP 316).
6. The role player 90 (FIG. 1) is given a time period to respond (STEP 318).
7. The role player 90 (FIG. 1) inputs a ready signal to computer (STEP 320).
8. The other player(s) 80 (FIG. 1) is given a time period to critique the response (STEP 322).
9. The other player(s) 80 (FIG. 1) inputs one of either an agree, disagree or pass (STEP 324).
10. The computer initiates the random event generator 60 (FIGS. 11, 12) (STEP 326).
11. The computer displays the random event generator 60 (FIGS. 11, 12) output and matches the other player(s) 80 scoring input and sums the value of the matches and assigns this score to the role player 90 (FIG. 1) (STEP 328).
12. The computer displays the role player's 90 (FIG. 1) acquired points and position (STEP 330), on the visual score tracker 158 (FIG. 15) wherein the position is based upon the nature of the acquired points as being one of either AGREE, DISAGREE or PASS.and subsequently advances the role player's animated game piece by one row into a matching column. In the event the role player 90 (FIG. 1) fails to match the other player(s) 80 (FIG. 1) inputs with the output of the random event generator 60 (FIGS. 11, 12) the role player 90 (FIG. 1) does not score any points for that turn.
13. The computer displays the players' 80 (FIG. 1) visual score tracker 158 (FIG. 15) positions (STEP 332) wherein the positions are based upon the nature of the most recently acquired points as being one of either AGREE, DISAGREE or PASS. Note that the role player 90 (FIG. 1) is not advanced if no points are scored and the role player's 90 (FIG. 1) previous position are displayed.
14. The computer selects the next role player 90 (FIG. 1) and repeats STEPS 316-334 (STEP 334).
15. Upon advancing a predetermined number of rows to the WINNERS' CIRCLE the computer ranks the players 80 (FIG. 1) reaching this position within a specified number of turns after the first player 80 (FIG. 1) reaches this position and sums the players 80 (FIG. 1) in the winner's circle by their respective score and declares a winner (STEP 236).
16. The players 80 (FIG. 1) end the game and terminate power to the computer (STEP 238).

In this embodiment an animated visual simulation of the random device generator 60 (FIGS. 11, 12) is provided to the monitor and the scoring of each individual player 80 (FIG. 1) is accomplished by a summation program embedded in the computer software routine that provides an output to an animated visual simulation of the game piece(s) 70 (FIG. 13) in conjunction with the alternate visual score tracker 168 (FIG. 15) that would indicate the individual player's 80 (FIG. 1) new position relative to this operation. Additional predetermined animation elements may be incorporated at the players' 80 (FIG. 1) discretion to enhance the participation and engagement of the players. This process would be collectively repeated for each individual player 80 (FIG. 1) until a winner is determined. In another embodiment, the animated visual game piece(s) 70 may comprise the form of any geometric shape, princesses, athletes, professionals, caricatures, fictional characters and items related to the theme of the scenario cards 10 (FIG. 2, 3) TABLE 1.

While the embodiments of the present invention disclosed herein are presently considered to be preferred, various changes and modifications can be made without departing from the spirit and scope of the present invention. The scope of the present invention is indicated in the appended claims, and all changes that come within the meaning and range of equivalents are intended to be embraced therein.

### LIST OF NUMERALS

| NUMBER | DESCRIPTION |
|---|---|
| 100 | SCENARIO GAME |
| 10 | SCENARIO CARD |
| 12 | SCENARIO CARD - FIRST SIDE |
| 14 | SCENARIO CARD - SECOND SIDE |
| 20 | DISAGREE CARD |
| 22 | DISAGREE CARD - FIRST SIDE |
| 24 | DISAGREE CARD - SECOND SIDE |
| 30 | PASS CARD |
| 32 | PASS CARD - FIRST SIDE |
| 34 | PASS CARD - SECOND SIDE |
| 40 | AGREE CARD |
| 42 | AGREE CARD - FIRST SIDE |
| 44 | AGREE CARD - SECOND SIDE |
| 50 | CONTAINER |
| 51 | CONTAINER - TOP SECTION |
| 52 | CONTAINER - TOP SECTION BASE |
| 53 | CONTAINER - TOP SECTION SIDE |
| 54 | CONTAINER - BOTTOM SECTION |
| 55 | CONTAINER - BOTTOM SECTION BASE |
| 56 | CONTAINER - BOTTOM SECTION SIDE |
| 58 | VISUAL SCORE TRACKER (CONTAINER - TOP SIDE) |
| 59 | FITTED CARD HOLDER (CONTAINER - BOTTOM SIDE) |
| 60 | RANDOM EVENT GENERATOR (DICE) |
| 61 | RANDOM EVENT GENERATOR (DICE) FIRST SIDE |
| 62 | RANDOM EVENT GENERATOR (DICE) SECOND SIDE |
| 63 | RANDOM EVENT GENERATOR (DICE) THIRD SIDE |
| 64 | RANDOM EVENT GENERATOR (DICE) FOURTH SIDE |
| 65 | RANDOM EVENT GENERATOR (DICE) FIFTH SIDE |
| 66 | RANDOM EVENT GENERATOR (DICE) SIXTH SIDE |
| 70 | GAME PIECE |
| 80 | PLAYER(S) |
| 90 | ROLE PLAYER |
| 158 | VISUAL SCORE TRACKER (ALTERNATE |
| | EMBODIMENT) |

TABLE 1
Example Scenarios

You're taking your best friends new 80k Mercedes Benz around the block for a test
drive when someone runs a stop sign and hits the car scratching the drivers side door
and continues driving. What would you do?
You're out on the town with co-workers and spot your brother-in-law in a deep lip lock a
woman who isn't your sister, but he doesn't see you. What would you do?
Your brother all ready owes you over $500.00 and now he needs you to bail him out of
jail. What would you do?
You're on an airplane that suddenly begins losing altitude. The pilot confirms that they
are experiencing engine problems, but everything is under control. What would you do?
You see an old family friend of the opposite sex in the store and you greet them with a
kiss. You get home and your child tells your spouse they saw you kissing another
man/woman. What would you do?
While sitting on your friend's new Italian leather sofa, your keys accidentally poke a hole
in it. What would you do?
Your neighbor's live-in adult child is seen on America's Most Wanted and there is a
$50,000.00 reward for their arrest. What would you do?
You took a detour on your way home from vacation to see your parents. You let
yourself in with your key only to find them having sex on the living room sofa. What
would you do?
While walking through a major department store, you notice you're being followed by
undercover security. What would you do?
Today is your 1^{st} year wedding anniversary and you didn't remember until your spouse
gave you their gift. What would you do?
While babysitting your mother's pet pooch, he suddenly begins choking and keels over
and dies. What would you do?
You're on your first date with Mr./Miss Wonderful. While laughing at your conversation
you make a mistake and pass gas a loud. What would you do?
At your family reunion, you discover that your cousin's new husband/wife is the same
person whose been dating one of your friends for the past 3 months. What would you
do?
You and a friend both spot someone you're attracted to while at a jazz festival, but find
out it's the same person. What would you do?
You live at home and your mother's new boyfriend is very controlling and you don't like
him. What would you do?
Your best friends' attractive father/mother compliments you and suggests you visit them
alone so they can spend some time getting to know you. What would you do?
You finally find the perfect pair of shoes to go with that outfit that's been hanging in your
closet for a month and they're a ½ size too small and tight. What would you do?
Your roommate of the past 2 years tells you that they're gay and that they're attracted to
you and would like to be more than friends. What would you do?
You witness a hit and run car accident that happened in front of your house and know
who the driver was. The police ask did you see anything. What would you do?
While over your new beaus house, his/her ex-calls stating their car broke down near
their house and wants to know if they can give them a ride home. They elect to go aid
the ex-. What would you do?
You and your boyfriend/girlfriend get back together a 3-week break-up. During the
break-up period your boyfriend/girlfriend slept with an associate of yours, but you heard
about it from another friend. What would you do?
Someone interested in you buys you an expensive piece of jewelry with no strings
attached. You're not attracted to them in the same way. What would you do?
You treat yourself to dinner of all your favorite foods. Just as you sit down to eat, your
sister and brother-in-law knock at the door with their 5 kids in tow. What would you do?
You notice a red mark on your girlfriend/boyfriends neck that looks like a passion mark
and you know you didn't put it there. What would you do?
You call home stating that you have to work late on a project, but it takes les time to
complete then you thought. You go home without calling and notice your best friends'
car in the driveway. As you walk to your door, you pass a window and see your friend
performing oral sex on your mate. What would you do?
You're invited to your best friend's last minute surprise birthday party and your spouse
comes home with tickets to a function you've been dying to attend for the both of you.
What would you do?
You're a single parent with 2 kids that attend different schools. They are both
participating in events that are happening at the same time on the same night. What
would you do?
Your best friend of 15 years is getting married. Your friend tells you that they've asked
someone they've known for only 2 years to be their best man/maid of honor but still
want you to be in the bridal party. What would you do?
Your best friend has confided to that he/she has broken the law and is wanted by the
police and begs you not to tell anyone. What would you do?
The three of you grew up together and are as close as brothers/sister. One friend tells
you a secret; he/she have been having sex with the others wife/husband. What would
you do?
You just received the promotion you've been praying for. Your mate comes home with
flowers and champagne telling you they've also received a promotion to a more
prestigious company making more money in another state. What would you do?
You arrive at the club looking sexy in your new outfit. Another female/male walks in
wearing the same thing, and is receiving a lot more compliments on how good they
look. What would you do?
You're home alone watching a good movie when your boyfriend/girlfriend comes over
unexpectedly and wants to watch the playoffs. What would you do?
You and a date go to a nice club and everyone is the place is on the dance floor.
You're feeling the music and anxious to dance when your date tells you they can't
dance and don't want to get on the floor. What would you do?
A co-worker has made a costly mistake to the company and you point it out to them. An
unexpected meeting has been called and the co-worker has placed the blame on you by
concocting false evidence that can be traced to you. What would you do?
You meet this person who tells you they have a fantastic job, car and house. You
exaggerate a bit on your home and job to try to impress them too. While working your
part-time job at the diner, that person comes in to eat. What would you do?
You're walking along a side street and find a purse lying beside a dumpster. You open
it to find some form of identification to return it but only find an undisclosed amount of
money. What would you do?
A policeman/policewoman pulls you over for speeding. You have a small amount of
marijuana and an unlicensed gun sticking out from under your seat. He/she sees the
items but tells you they will overlook the situation if you have sex with them. What
would you do?
You and your roommate share a studio apartment with twin beds. You both come home
with dates. What would you do?
Your son/daughter is deeply in love with their mate and shares a child with them. While
out one night, you see him/her intimately kissing someone else. What would you do?
A person you have been dating for 2 months invites you over for a home-cooked meal.
They walk you into the dining room where the table is set with flowers, wine and candles
and you see a roach crawling across your empty plate. What would you do?
You're driving along a dark road late at night and your car stops unexpectedly. You
don't have a cell phone so you wait the hour it takes before someone else happens
along. A car approaches and offers you a ride in exchange for a personal favor. What
would you do?
After hours of shoveling yourself out of a foot of snow, you go to the grocery store to get
the necessities. When you arrive back home you find a neighbors car parked in the
undesignated space you cleared. What would you do?
A not so close cousin from another state comes to visit you and decides they want to
relocate to your area. They didn't mention they had no job, money and need to stay at
your place until he/she gets on their feet. What would you do?
While at the club, a male/female walks up to one of your friends and they exchange
unfriendly words. As you all turn to walk away the instigator hits your friend over the
head with a bottle. What would you do?
Your friend calls you while they are out shopping and tells you they're watching your
girlfriend/boyfriend buy a person of the opposite sex a piece of jewelry. What would you
do?
Your mother invites you to a party that she's hosting at her home. At the party she is
drinking heavily and begins a strip tease act in front of her guests. What would you do?
You receive a picture in the mail of your boyfriend/girlfriend kissing someone other than
you. The date on the picture states it was taken a week ago when he/she was away on
a business trip. What would you do?
You've been in love with your best friend of the opposite sex for years and finally found
the nerve to tell them. While hanging out they announce that they've been secretly
dating someone and they want you to meet him/her for the final approval. What would
you do?
You're at a red light and see an acquaintance from the old neighborhood that asks for a
ride up the street. You agree to take them and head off when suddenly; police
surrounds the car. They pull you both from the car and begin searching it and find a
pound of marijuana in a bag under the passenger seat and the acquaintance says it's
not theirs and you're a non-smoker. What would you do?
Your 16year old has been acting strange lately and you investigate by checking their
room. During you once over, you find a pill and a small bag of marijuana in their
underwear drawer. What would you do?
Your 15year old daughter solicits your help for a friend who says her stepfather is
molesting her. What would you do?
You receive a notice from Child Protective Services that you're being investigated for
alleged abuse of your children. During the meeting you discover that your child is the
one who made the complaint. What would you do?
Your stepchild is an angel when they're with the both of you, but as soon as their
mother/father leaves they turn into the devil himselt talking back and disobeying you.
What would you do?
You agree to meet your date at the theater at 7:45 for an 8:00 pm show that you
purchased tickets for. At 8:15 you call their cell phone repeatedly and get no answer,
but leave a message for them to pick up the tickets at will call. By intermission they still
have not called, returned your calls or showed up. What would you do?
You make a pornographic video for your spouse. You come home to find him/her
watching the tape with their friend. What would you do?
You catch your husband/wife in bed having sex with their best friend of the same sex.
What would you do?
You converse with a man/woman at the local bar and aren't ready for the night to end
when the bar closes. They invite you over to their place for a continuation and when
you get there the place is a total wreck. What would you do?
Your supervisor has a tendency to speak to you at close range and his breath usually
stinks. Today you just can't take it anymore. What would you do?
Your 13 year old daughter asks to be put on birth control. What would you do?
Your 17 year old son says a girl he had sex with is pregnant and he is one of 3 young
men who could be the father. What would you do?
You just saved $1,500.00 to buy that 52″ television for the Super Bowl Party you're
having. Your mother calls stating that she needs $1,200.00 or she'll be evicted from her
apartment. What would you do?
You're against the war and your son just received his draft letter. What would you do?
You and a young lady that you don't know are waiting at the bus stop. Three young
men come along and begin to harass and push the young lady around for no apparent
reason. What would you do?
While at the checkout counter, the cashier gives you back $10.00 too much in change.
What would you do?
You receive a call asking for someone who does not live in your house and hang up
after telling the person they have the wrong number. The person on the other end calls
back stating that you have a nice voice and asks if they can talk to you. What would
you do?
You're being introduced to the person who will be making the final decision on your
business loan. When they reach out to shake your hand, you notice they only have 2
fingers, a thumb and pinky. What would you do?
You're driving back to work from your lunch break and notice a car weaving in and out
of their land, stopping in the middle of intersections and running red light. What would
you do?
You try a new salon and the person scheduled to do your hair did a horrible job on the
person who was in the chair before you. What would you do?
While at a red light, the profile of the person driving beside you looks exactly like your
spouse and they're with an unfamiliar person of the opposite sex. Just as you roll down
your window, they turn the corner. What would you do?
You've just picked up your order from a fast food restaurant. While you're inspecting
the contents, a restaurant worker drops a bun on the floor and puts it on top of a burger
thinking no one saw them. What would you do?
You're lying out on the beach with your eyes closed relaxing when you suddenly feel the
presence of someone near. When you open your eyes there is a person there filming
your with their video camera. What would you do?
You take your car to the auto shop asking for an oil change but when you return the
mechanic billed you for a tune-up and servicing the air conditioner. What would you
do?
You have a childhood friend who's involved in illegal activities. They inform you that
they think they're being watched and ask if you could hold a package for them. What
would you do?
You take that special person home to meet your family. While there your cousin who
has always been jealous of you begins to openly flirt with your girl/guy in front of
everyone. What would you do?
Your boyfriend/girlfriend of 2 years invites you to their family reunion. While there, an
aunt of theirs keeps calling you the name of your boyfriend/girlfriends ex-even after
you've corrected 5 times. What would you do?
Your friend has tried every diet on the market and looks to be gaining weight instead of
losing it. One day they ask you, “Does it look like I've lost any weight?” What would
you do?
Your lover invites you over for an evening of romance. When you get there, he/she tells
you that another person is coming for the same reason. What would you do?
While looking out your window, you notice a bible-toting group going door-to-door
around the neighbor, then suddenly, there's a knock at your door. What would you do?
The morning of your wedding, someone tells you that your fiance had sex with a stripper
at the bachelor/bachelorette party. What would you do?
Someone gives you money to play a lottery number but you forgot. They call you later
stating they won $250.00 off that number and will be there shortly to get the ticket.
What would you do?
Someone tells you to play a lottery number for them but didn't give you any money.
You go to the store and play the number for yourself and win. Later that day they asked
if you played the number because they believe they are entitled to half the winnings
since they gave you the number. What would you do?
You don't have all the money for this month's rent and if you pay it late again, you will
be evicted. An acquaintance that wants to be more offers to pay the entire amount for a
sexual favor. What would you do?
While coming out of the movies, you see a group of teenage girls beating up a
homeless person. What would you do?
You plan to surprise your lover by coming over unexpectedly for an overnight stay.
When they open the door, you see they all ready have someone there resting
comfortable on the sofa. What would you do?
Your boyfriend/girlfriend decided to treat you to a special evening that consisted of your
favorite restaurant and then to the play you've been dying to see. To top it off, they
even purchased the outfit for you to wear. With them standing there, you open the box
that contained the ugliest outfit you had ever seen. What would you do?
You visit a friend who just had a baby and the baby isn't cute at all. As they're offering
the child for you to hold they ask, “Isn't she cute?” What would you do?
You overheard your supervisor tell another manager that they're about to fire your on-
the-job friend. What would you do?
After being broke up for over a year, the ex-that your current beau HATES calls and
offers you a position at their new company making double your current salary. What
would you do?
While in another part of the house, you pick up the phone to make a call but hear your
boyfriend/girlfriend speaking on the line. Instead of hanging up you listen and overhear
your boyfriend/girlfriend make plans to meet this person of the opposite sex. What
would you do?
You're single and dating two very nice people who don't know there is someone else.
One has an executive job, is slightly arrogant and lives lavish lifestyle, but they are
terrible in bed. The other is a struggling student with great potential, has a very easy-
going attitude about life and is a great lover. They both want a commitment. What
would you do?
You're engaged to be married but aren't completely happy with your sex life. You've
tried all kinds of things to get your partner more involved but nothing seems to work with
the consistency you need and you're usually left feeling unfulfilled afterwards. What
would you do?
Your live-in travels a lot on with their job leaving you home alone quite often. While at
your mailbox an attractive neighbor of the opposite sex approaches and strikes up a
conversation asking if you would like to meet for drinks at a bar not too far away. What
would you do?
Your work buddy has made friends with someone you don't particularly care for and
now he/she has asked to hang out with the two of you on your lunch break and down
time at the work place. What would you do?
Your family comes to town for a visit to finally meet the person you've been dating. The
initial “hellos” go well and you send your partner out to pick up desert. They are gone
for hours and not answering the cell phone and when they get back they're intoxicated
and without desert. What would you do?
You awake with a tummy ache and spend most of the morning in the bathroom relieving
your self. You drive the 45 minutes to work without incident and settle in, but then you
feel a gas bubble forming. You're alone in your office so you release the pressure
thinking it's a fart, only to be met with a slither of poop in your pants. What would you
do?
You walk into a public bathroom to urinate, but once you stoop, you realize you have to
poop. You begin to let loose and notice there's no toilet paper in the stall. What would
you do?
It's your birthday and your friends take you out for drinks after work. You're having so
much fun that you forget to call your boyfriend/girlfriend and notice hours later you've
missed numerous calls from them. What would you do?
Your sister has gone through a period of hard times and comes to you for help with her
2 kids. She asks if her children can move in with you, your spouse and 3 kids until she
is able to take care of them. What would you do?
A gay same sex has told everyone in the office that they have a crush on you and now
you are the center of office jokes. What would you do?
While cleaning the house, you find a used condom behind the living room sofa. Your
house consists of you, your husband/wife, 15 year old daughter and 13 year old son.
What would you do?
You live near the park that's the hangout of all the neighborhood kids. Late one night,
you see your neighbor's 15 year old daughter having sex on the picnic table with a boy.
What would you do?
One of your co-workers has a bad case of body odor and everyone jokes about it
behind his back. One day, he happens to come into the conference room while
everyone is making jokes about him and he asks you what's so funny. What would you
do?
Your female cousin is involved with your best male friend. She tells you she is
pregnant, but isn't sure if the baby is his because she cheated around the same time
she conceived. What would you do?
A co-worker invites you to a party at their home and you want to go without your
boyfriend/girlfriend. What would you do?
Your husband/wife tells you they're going to a club with a friend that you know of. The
friend calls the house looking for them not knowing they used them as an alibi. What
would you do?
Before getting married, your fiance' decides to confess of an affair he/she had with an
ex-co worker. What would you do?
You've found evidence that your boyfriend/girlfriend of 1 year is cheating, so you break
off the relationship. The same evening, you visit his/her place to talk about it and find
that they're not alone. What would you do?
A month before your wedding, you receive a call from the Maury Povich Show asking
you to be a guest. What would you do?
You have a friend that is HIV positive and they have pursued a relationship with
someone who does not know. What would you do?
A wealthy entertainer promises to pay you $100,000.00 to spend a weekend with them
although they know you're married. What would you do?
While standing in line at a store, the person in front of you unknowingly drops a fifty
dollar bill (money) on the floor in front of you. What would you do?
You approach someone that you're attracted to in the club, but their friend is making
moves on you instead of them. What would you do?
You mate is spending a lot of time with your brother/sister and you believe that they are
having an affair. What would you do?
While talking to a co-worker you can't help but see that they have a booger hanging
from their nose. What would you do?
Your friend had too much to drink but still insists on driving home. What would you do?
You start a restaurant business and let one of your childhood friends manage it. Six
months into their employment, you notice a cash shortage and an increase to their
spending. What would you do?
You're friends house is a nasty mess and they ask if you would help them clean it.
What would you do?
You're dating someone who is very nice but you they have obvious hygiene issues.
What would you do?
You're married and on vacation with a group of childhood friends. While away, you
meet someone you're attracted to and they ask if you'd like to spend the night with
them. What would you do?
You've been married for 2 months and notice that your husband/wife hasn't worn their
wedding band for the last 2 weeks. What would you do?
You meet an attractive person while at a happening nightclub. Things get steamy
between the two of you & you begin to make out in a dark corner in the club. When the
lights come on, you notice that the person is the same sex as you. What would you do?
You allow your friend to set you up on a blind date. When you arrive at the designated
meeting place, you take a peck at the person and do not like what you see. What would
you do?
While walking around the mall, you notice an attractive male/female and give them a
lingering look. Their mate noticed you looking and makes a threatening remark towards
you. What would you do?
After chatting and dating someone over the Internet for over a month, you begin dating.
You have every telephone number except the home number and when you ask about it
they get defensive and an argument begins. What would you do?
After a night of heavy drinking, you and your spouse disclose secrets supposedly told to
no one else. They confess to having had oral sex performed on them “one time” by a
person of the same sex. What would you do?
While out on a date, the person attempts to kiss you and their breath smells like they've
been eating trash. What would you do?
You loan a family member $1,000.oo and they leave town without telling you or paying
you back. Three months later, the same family member attends a family function
bragging about their newfound success. What would you do?
You meet someone and have decided to exchange telephone numbers. You supply
your home and cell number, but they only give you their cell number. What would you
do?
An ex-lover, who is now married, is in town on business and they call and invite you out
for dinner. While out some old feelings resurface and they ask you to stay the night at
their hotel. What would you do?
Two co-workers are at odds. While at lunch, you overhear one of them make a
telephone call telling someone to do damage to the others vehicle. What would you do?

What is claimed is:

1. A scenario card game comprising:
a deck of scenario cards, a deck of pass cards, a deck of agree cards, a deck of disagree cards; each deck respectively having a predetermined shape, and a random event generator; wherein two or more players assume a role upon randomly selecting a scenario card (hereafter, role player), reading it aloud to the other player(s) and fashioning a response, subsequently the other player(s) select a pass, agree or disagree card, each of which is assigned a unique point value, the role player elicits a response from the random event generator that corresponds with either the pass, agree or disagree mode and the role player is assigned the points based on the corresponding selection by the other player(s), the turn then proceeds to the next player.

2. The scenario game of claim 1, further comprising a container consisting of a rectangular box having a top section and bottom section, each respectively having a rectangular base and four sides in congruent agreement with the respective edges of the rectangular base, wherein the bottom section is slightly smaller than the top section so as to be received therein.

3. The scenario game of claim 1, further comprising individual player game pieces and the container top section having an integrated visual score tracker (as shown by FIG. 10) whereby any number of players can denote and visually ascertain their respective progress by moving their respective game piece to a predetermined location corresponding to the player's score on said visual score tracker.

4. The scenario game of claim 1, further comprising individual player game pieces and the container top section having an integrated visual score tracker (as shown by FIG. 15) whereby any number of players can denote and visually ascertain their respective progress by moving their respective game piece to a predetermined location corresponding to the player's score on said visual score tracker.

5. The scenario game of claim 1, further comprising a visual score tracker of separable foldable construction, which is designed to permit storage within the container.

6. The container bottom section of claim 2, further comprising a fitted holder having designated user accessible locations for the placement of the scenario, pass, agree, disagree cards, game pieces and the random event generator.

7. The random event generator of claim 1 further comprising a dice having the symbols A (agree), D (disagree), and P (pass) each respectively assigned to opposite faces of the dice.

8. The deck of scenario cards of claim 1 wherein the number of cards in a deck has a range comprising twenty five to two hundred cards.

9. The deck of pass cards of claim 1 wherein the number of cards in a deck has a range comprising twenty five to three hundred cards.

10. The deck of agree cards of claim 1 wherein the number of cards in a deck has a range comprising twenty five to seven hundred cards.

11. The deck of disagree cards of claim 1 wherein the number of cards in a deck has a range comprising twenty five to seven hundred cards.

12. The scenario card game of claim 1 wherein the predetermined shape of the scenario, pass, agree and disagree card decks is chosen from a geometric group consisting of rectangles, ellipses, stars, triangles, diamonds and regular polygons.

13. The scenario cards of claim 1 wherein the scenarios are selected from a group of life experiences consisting of romantic/sexual experiences, financial dilemmas, spiritual matters, work/career experiences, educational experiences, family matters, pop culture and health related issues.

14. The scenario cards of claim 1 wherein the scenarios are selected from a group of fictional experiences consisting of romantic/sexual fantasies, cartoon caricatures, science fiction, television drama, political fantasy, sports fantasy and gossip issues.

15. The scenario cards of claim 14 wherein the scenarios are specifically tailored to a specific age group selected from a group consisting of pre-teen children, teenagers, young adults, middle-age adults and seniors.

16. The individual player game pieces of claim 3, further comprising the shape of a question mark having a base to provide self-support while it is moved about the visual score tracker, each having one of either a unique pattern or a predetermined color to distinguish an individual player,

17. A method for playing a scenario game which comprises the steps of:
a.) Selecting a first role player from a group of two or more participants;
b.) Having the role player randomly select a scenario card from the scenario card deck, and read the selected card aloud to the other participants;
c.) Having the role player fabricate a response to the scenario within an allotted period of time, and stating this response aloud to the other participants;
d.) The other participants upon hearing the scenario and the role player's response, evaluate the response by selecting one of either an agree, a disagree or a pass card;
e.) Subsequent to the other participants completing their evaluation, the role player tosses the random event generator (dice) and collects the cards from those participants that match the output of the random event generator (dice), thereby acquiring points;
f.) The other players then place the unselected cards in one of either a discard pile or return them to their respective deck;
f.) The role player's turn is then passed onto the next player, who repeats steps (a.) through (e.) until one of either of the following events occur:
(1.) All of the cards from one of either the pass, agree or disagree decks have been exhausted,
(2.) Any arbitrary point total is reached by one of the players, or
(3.) The players mutually agree to conclude the game.

18. The method of claim 17 further comprising a step for utilizing a visual score tracker and a game piece, wherein:
a.) Each player selects a representative game piece and places said game piece on a designated starting position on a visual score tracker;
b.) Selecting a first role player from a group of two or more participants;
c.) Having the role player randomly select a scenario card from the scenario card deck, and read the selected card aloud to the other participants;
d.) Having the role player fabricate a response to the scenario within an allotted period of time, and stating this response aloud to the other participants;
e.) The other participants upon hearing the scenario and the role player's response, evaluate the response by selecting one of either an agree, a disagree or a pass card;
f.) Subsequent to the other participants completing their evaluation, the role player tosses the random event generator (dice) and collects the cards from those participants that match the output of the random event generator (dice), thereby acquiring points if any matching cards are collected;
g.) Moving the role player's game piece to a position on the visual score tracker corresponding to the number of any points acquired;
h.) The role player's turn is then passed onto the next player, who repeats steps (a.) through (g.) until one of either of the following events occur:
(1.) All of the cards from one of either the pass, agree or disagree decks have been exhausted,
(2.) Any arbitrary assigned point total is reached by one of the players, or
(3.) The players mutually agree to conclude the game.

19. The method of claim 17 further comprising a step for utilizing a visual score tracker and a game piece, wherein:
a.) Each player selects a representative game piece and places said game piece on a designated starting position on a visual score tracker;
b.) Selecting a first role player from a group of two or more participants;
c.) Having the role player randomly select a scenario card from the scenario card deck, and read the selected card aloud to the other participants;
d.) Having the role player fabricate a response to the scenario within an allotted period of time, and stating this response aloud to the other participants;
e.) The other participants upon hearing the scenario and the role player's response, evaluate the response by selecting one of either an agree, a disagree or a pass card;
f.) Subsequent to the other participants completing their evaluation, the role player tosses the random event generator (dice) and collects the cards from those participants that match the output of the random event generator (dice), thereby acquiring points if any matching cards are collected;
g.) Moving the role player's game piece to a position on the visual score tracker corresponding to the number of any points acquired;
h.) The role player's turn is then passed onto the next player, who repeats steps (a.) through (g.) until one of either of the following events occur:
(1.) All of the cards from one of either the pass, agree or disagree decks have been exhausted,
(2.) Any arbitrary assigned point total is reached by one of the players, or
(3.) The players mutually agree to conclude the game.

20. A scenario game comprising a computer implemented animated software program wherein a software driver provides visual and audio output based upon a predetermined input received by at least one player in operable communication with said program, wherein the program steps are initiated in the following sequence:
a. The players initiate power to the computer and start the game,
b. The number of players is input into the computer,
c. The players select representative game pieces,
d. A player is selected by the computer to be the first role player
e. A random scenario is assigned by the computer to the role player,
f. The role player is given a time period to respond,
g. The role player inputs a ready signal to computer,
h, The other player(s) are given a time period to critique the role player's response.
i. The other player(s) inputs one of either an agree, disagree and pass to the computer.
j. The computer initiates a random event generator.
k. The computer displays the random event generator output.
l. The computer matches the random event generator output and the other player(s) scoring input and sums the value of the matches and assigns this score to the role player.
m. The computer displays the role player's acquired points and position.
n. The computer displays the other players' visual score tracker position based upon the nature of the acquired points as being one of either AGREE, DISAGREE or PASS.and subsequently advances the role player's animated game piece by one row into a matching column.
o. The computer selects the next role player and repeats (d) through (n).
p. Upon advancing a predetermined number of rows to the WINNERS' CIRCLE the computer ranks the players reaching this position within a specified number of turns after the first player reaches this position and sums the players in the winner's circle by their respective score and declares a winner.
q. The players end the game and terminate power to the computer.
